(19) United States
(12) Patent Application Publication
(10) Pub. No.: US 2020/0127362 A1
(43) Pub. Date: Apr. 23, 2020

(54) METHOD, CONTROL DEVICE, AND SYSTEM FOR SATELLITE SWITCHING OF MOTOR ANTENNA

(71) Applicant: HUAWEI TECHNOLOGIES CO., LTD., Shenzhen (CN)

(72) Inventor: Diandong YANG, Shenzhen (CN)

(21) Appl. No.: 16/722,091

(22) Filed: Dec. 20, 2019

Related U.S. Application Data
(63) Continuation of application No. PCT/CN2018/091183, filed on Jun. 14, 2018.

(30) Foreign Application Priority Data
Jun. 26, 2017 (CN) 201710495503.4

(51) Int. Cl. H01Q 1/12; H01Q 3/08; H01Q 3/22; H04N 21/61; H04N 21/438

(52) U.S. Cl. CPC H01Q 1/1257; H01Q 3/08; H04N 21/438; H01Q 3/22; H04N 21/6143; H01Q 1/1264

(57) ABSTRACT

A method includes determining, based on a satellite longitude of stored parameters of a target channel, that a current channel and the target channel correspond to satellites of different longitudes, controlling a power supply for a motor based on a power supply voltage for an antenna having a second polarization in response to determining, based on a channel polarization of the stored parameters of the target channel, that a polarization of a satellite-transmitted radio wave of the target channel is a first polarization, sending a rotation instruction to the motor, determining that the motor rotates to a preset position, and controlling the antenna to receive a signal having the first polarization in response to determining that the motor rotates to the preset position. The power supply voltage for the antenna having the second polarization is larger than a power supply voltage for the antenna having the first polarization.

### CROSS-REFERENCE TO RELATED APPLICATIONS

This application is a continuation of International Application No. PCT/CN2018/091183, filed on Jun. 14, 2018, which claims priority to Chinese Patent Application No. 201710495503.4, filed on Jun. 26, 2017, the disclosures of which are hereby incorporated by reference in their entireties.

### TECHNICAL FIELD

This application relates to the communications field, and in particular, to a method, a control device, and a system for satellite switching of a motor antenna.

### BACKGROUND

In European, American and African countries, users all watch TV programs via satellite. In these countries and regions, there are often several TV operators, each having a proprietary channel. In addition, these TV operators' proprietary channels are distributed on satellites in different orbits. The most direct way for a user to receive different channels is to install a digital satellite equipment control (DiSEqC) motor antenna. It takes time for a motor antenna to switch between different satellite orbits. As a result, there is a long waiting time before a set-top box changes to a new channel, affecting user experience.

Therefore, how to reduce time required for a motor to rotate to a preset position in switching between programs over different satellites is an urgent problem to be resolved.

### SUMMARY

At least one embodiment of the present disclosure provides a method, a control device and a system for satellite switching of a motor antenna, so as to reduce a time for a motor to rotate to a preset position in switching between programs over different satellites, thereby improving user experience.

According to at least one embodiment, a method for satellite switching of a motor antenna includes: determining, based on a satellite longitude in read parameters of a target channel, that a current channel and the target channel correspond to satellites of different longitudes; controlling power supply for a motor based on a power supply voltage for the antenna in a second polarization manner, when it is determined, based on a channel polarization manner in the parameters of the target channel, that a polarization manner of a satellite-transmitted radio wave that sends a signal of the target channel is first polarization, where the power supply voltage for the antenna in the second polarization manner is higher than a power supply voltage for the antenna in a first polarization manner; sending a rotation instruction to the motor; determining that the motor rotates to a preset position; and controlling the antenna to receive the signal using the first polarization manner, when it is determined that the motor rotates to the preset position.

Therefore, in some embodiments, when it is determined, based on the channel polarization manner in the parameters of the target channel, that the polarization manner of the satellite-transmitted radio wave that sends the signal of the target channel is the first polarization, power supply for the motor is controlled based on the power supply voltage for the antenna in the second polarization manner; and when it is determined that the motor rotates to the preset position, the antenna is controlled to receive the signal using the first polarization manner. Because the power supply voltage for the antenna in the second polarization manner is higher than the power supply voltage for the antenna in the first polarization manner, rotation of the motor can be accelerated, and time for the motor to rotate to the preset position is reduced in switching between programs over different satellites, thereby improving user experience.

In some embodiments, when the control device determines, based on the satellite longitude in the read parameters of the target channel, that the current channel and the target channel correspond to satellites of a same longitude, the control device further determines, based on a channel polarization manner in the parameters of the target channel and a channel polarization manner in parameters of the current channel, whether the polarization manner of the current channel is the same as the polarization manner of the target channel; and if the two polarization manners are different, the control device adjusts the polarization manner of the antenna so that the polarization manner of the antenna is the same as the polarization manner of the target channel.

In some embodiments, before the control device determines, based on the satellite longitude in the read parameters of the target channel, that the current channel and the target channel correspond to satellites of different longitudes, the method further includes: receiving, by the control device, channel switching information, and reading the parameters of the target channel based on the channel switching information.

In some embodiments, the first polarization is vertical polarization and the second polarization is horizontal polarization.

In some embodiments, the first polarization is right-handed polarization and the second polarization is left-handed polarization.

In some embodiments, the controlling power supply for a motor based on a power supply voltage for the antenna in a second polarization manner, when it is determined, based on a channel polarization manner in the parameters of the target channel, that a polarization manner of a satellite-transmitted radio wave that sends a signal of the target channel is first polarization, includes: adjusting a channel polarization manner in stored parameters of the target channel to the second polarization when the polarization manner of the satellite-transmitted radio wave that sends the signal of the target channel is the first polarization; and

determining, based on the second polarization manner in the parameters of the target channel, to supply power for the motor using the power supply voltage for the antenna in the second polarization manner; and

the controlling the antenna to receive the signal using the first polarization manner, when it is determined that the motor rotates to the preset position, includes:

restoring the stored polarization manner of the satellite-transmitted radio wave that sends the signal of the target channel to the first polarization; and

controlling the antenna to receive the signal using the first polarization manner, based on the restored first polarization manner of the satellite-transmitted radio wave that sends the signal of the target channel.

Therefore, in some embodiments, when it is determined, based on the channel polarization manner in the parameters of the target channel, that the polarization manner of the satellite-transmitted radio wave that sends the signal of the target channel is the first polarization, the polarization manner of the antenna for receiving the satellite-transmitted radio wave is adjusted to the second polarization, and power supply for the motor is controlled based on the power supply voltage for the antenna in the second polarization manner. Because the power supply voltage for the antenna in the second polarization manner is higher than the power supply voltage for the antenna in the first polarization manner, rotation of the motor can be accelerated, and a time for the motor to rotate to the preset position is reduced in switching between programs over different satellites in vertical (right-handed) polarization.

In some embodiments, the determining whether the motor rotates to a preset position includes:

detecting a power supply current of the antenna after the rotation instruction is sent to the motor; and determining, based on the power supply current of the antenna, that the motor rotates to the preset position.

In some embodiments, that the determining, that the motor rotates to a preset position based on the power supply current of the antenna, includes: determining that the motor rotates to the preset position when a difference between the power supply current of the antenna and a power supply current of the antenna before the motor rotation instruction is sent is less than a first threshold.

In some embodiments, that the determining that the motor rotates to a preset position based on the power supply current of the antenna, includes: determining that the motor rotates to the preset position when the power supply current of the antenna is a first power supply current, where the first power supply current is a working current of a high frequency tuner.

In some embodiments, the determining that the motor rotates to a preset position includes: receiving a first message sent by the motor, where the first message is used to indicate that the motor rotates to the preset position; and determining, based on the first message, that the motor rotates to the preset position.

According to at least one embodiment, a control device for satellite switching of a motor antenna is provided, including: a determining module, an adjusting module, a control module, and a sending module, where the control device is able to perform the method according to any one of the first aspect or the optional implementations of the first aspect.

According to at least one embodiment, a system for satellite switching of a motor antenna is provided, including a control device for satellite switching of a motor antenna, a motor, and an antenna, where the system is able to perform the method according to any one of the first aspect or the optional implementations of the first aspect.

According to at least one embodiment, a control device for satellite switching of a motor antenna is provided, including: a memory, a processor, and a transceiver, where the memory stores program code that can be used to instruct to perform the method according to one or more of the embodiments described herein—and the transceiver is configured to perform specific sending or receiving of a signal under driving of the processor; and when the code is executed, the processor can implement the operations performed by the terminal control device in the method.

According to a at least one embodiment, a computer storage medium is provided, where the computer storage medium stores program code, and the program code can be used to instruct to perform the method according to one or more of the embodiments described herein.

### BRIEF DESCRIPTION OF DRAWINGS

FIG. 1 is a schematic diagram of a satellite signal ground receiving system of a method and a control device for satellite switching of a motor antenna according to at least one embodiment of the present disclosure;

FIG. 2 is a schematic flowchart of a method for satellite switching of a motor antenna according to at least one embodiment of the present disclosure;

FIG. 3 is a schematic block diagram of a control device for satellite switching of a motor antenna according to at least one embodiment of the present disclosure; and

FIG. 4 is a schematic block diagram of a control device for satellite switching of a motor antenna according to at least one embodiment of the present disclosure.

### DETAILED DESCRIPTION

To make a person skilled in the art understand the solutions in the present disclosure better, the following describes several embodiments in more detail with reference to the accompanying drawings and implementations. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

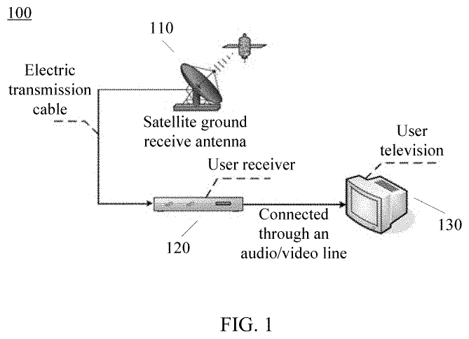

FIG. 1 is a schematic diagram of a satellite signal ground receiving system of a method and a control device for satellite switching of a motor antenna according to at least one embodiment of the present disclosure. As shown in FIG. 1, the satellite signal ground receiving system 100 includes a receive antenna 110, a user receiver 120, and a television 130. The receive antenna 110 includes a receive antenna, a feed, a high frequency tuner, and a motor (not shown). The antenna receives a satellite signal and sends the signal to the feed. The feed converts the received microwave signal into an electrical signal and sends it to the high frequency tuner. The high frequency tuner, also known as a low-noise block downconverter (LNB), down-converts the satellite signal sent by the antenna 110, amplifies the signal and sends the amplified signal to the user receiver 120. The user receiver 120 performs low-noise amplification, frequency conversion and demodulation processing on the electrical signal from the high frequency tuner, and outputs a full television band signal to the television 130.

When a user changes a channel, the user receiver 120 first switches to parameters of a target channel based on received channel switching information, then determines whether a satellite orbit of the target channel coincides with a satellite orbit of a current channel; and if the satellite orbit of the target channel does not coincide with the satellite orbit of the current channel, sends a rotation instruction to the motor, controlling the motor to drive the antenna to rotate to a preset position to receive a satellite signal of the target channel.

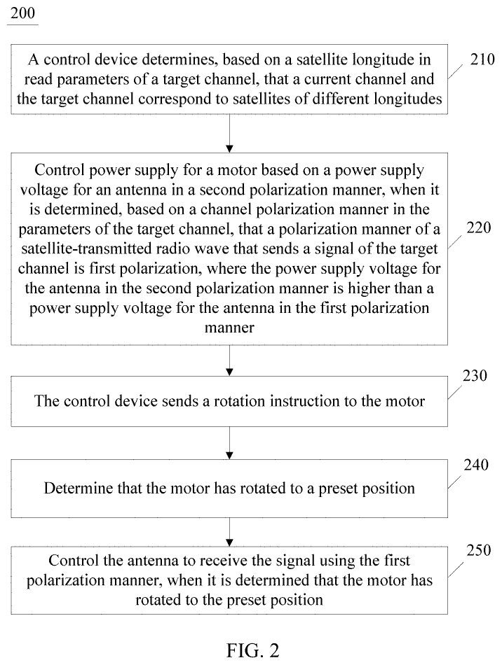

FIG. 2 is a schematic flowchart of a method 200 for satellite switching of a motor antenna according to at least one embodiment of the present disclosure.

As shown in FIG. 2, the method 200 includes the following content.

At operation 210, a control device determines, based on a satellite longitude in read parameters of a target channel that a current channel and the target channel correspond to satellites of different longitudes. In some embodiments, the control device of FIGS. 1-4 includes the user receiver 120.

In some embodiments, before the control device determines, based on the satellite longitude in the read parameters of the target channel, that the current channel and the target channel correspond to satellites of different longitudes, the method further includes: receiving, by the control device, channel switching information, and reading the parameters of the target channel based on the channel switching information.

Specifically, channel information parameters stored in the control device are described in Table 1. When a user is watching the HBO channel and wants to watch CCTV1, the control device receives channel switching information and reads parameters of CCTV1 based on the channel switching information; and determines that the current channel and the target channel correspond to satellites of different longitudes, because a satellite longitude of HBO is 76.5 degrees, and a satellite longitude of CCTV1 is 115 degrees.

TABLE 1
Channel information parameters stored in the control device

| | | Downstream | Symbol | | | | Channel | | Satellite |
|---|---|---|---|---|---|---|---|---|---|
| Channel | Name | frequency | rate | FFC | VPID | APID | polarization | Modulation | longitude |
| 1 | BBC | 12260 | 27500 | ¾ | 33 | 34 | Horizontal | DVB-S | 76.5 |
| 2 | HBO | 12450 | 1480 | ½ | 512 | 608 | Vertical | DVB-S2 | 76.5 |
| 3 | CCTV1 | 12515 | 2200 | ⅔ | 527 | 650 | Vertical | DVB-S | 115 |
| 4 | VOA | 12386 | 3600 | ¾ | 257 | 258 | Horizontal | DVB-S2 | 138 |

In some embodiments, when the control device determines, based on the satellite longitude in the read parameters of the target channel, that the current channel and the target channel correspond to satellites of a same longitude, the control device further determines, based on a channel polarization manner in the parameters of the target channel and a channel polarization manner in parameters of the current channel, whether the polarization manner of the current channel is the same as the polarization manner of the target channel; and if the two polarization manners are different, the control device adjusts the polarization manner of the antenna so that the polarization manner of the antenna is the same as the polarization manner of the target channel.

At operation 220, a power supply (not shown) for a motor is controlled based on a power supply voltage for the antenna in a second polarization manner different from first polarization, when it is determined, based on a channel polarization manner in the parameters of the target channel, that a polarization manner of a satellite-transmitted radio wave that sends a signal of the target channel is first polarization, where the power supply voltage for the antenna in the second polarization manner is higher than a power supply voltage for the antenna in a first polarization manner. In some embodiments, the power supply is controlled by the control device.

In some embodiments, the first polarization is vertical polarization and the second polarization is horizontal polarization.

In some embodiments, the first polarization is right-handed polarization and the second polarization is left-handed polarization.

In some embodiments, there are two polarization manners for a satellite television broadcast signal: linear polarization and circular polarization, where the linear polarization manner can be further divided into horizontal polarization and vertical polarization; and the circular polarization manner can be further divided into left-handed circular polarization and right-handed circular polarization. Horizontal polarization means that when a satellite transmits a signal to the ground, a vibration direction of a radio wave of the signal is horizontal. Vertical polarization means that when a satellite transmits a signal to the ground, a vibration direction of a radio wave of the signal is vertical. When a satellite antenna receives a satellite television broadcast signal, a polarization manner of the antenna needs to be the same as a polarization manner of the received satellite television broadcast signal to achieve polarization matching, or else the satellite television broadcast signal cannot be received.

In some embodiments, when the polarization manner of the antenna is horizontal polarization, the power supply voltage for the antenna is 18 volts, and when the polarization manner of the antenna is vertical polarization, the power supply voltage for the antenna is 13 volts.

In some embodiments, when it is determined, based on the channel polarization manner in the parameters of the target channel, that the polarization manner of the satellite-transmitted radio wave that sends the signal of the target channel is the second polarization, the control device controls a power supply voltage for the antenna based on a power supply voltage for the antenna in a second polarization manner, and sends a rotation instruction to the motor.

It should be understood that the antenna polarization manners in this application are used as examples, and the polarization manner of the antenna for receiving the satellite-transmitted radio wave may alternatively be elliptical polarization. The present disclosure is not limited thereto.

In some embodiments, the controlling power supply for a motor based on a power supply voltage for the antenna in a second polarization manner, when it is determined, based on a channel polarization manner in the parameters of the target channel, that a polarization manner of a satellite-transmitted radio wave that sends a signal of the target channel is first polarization, includes:

adjusting a channel polarization manner in stored parameters of the target channel to the second polarization when the polarization manner of the satellite-transmitted radio wave that sends the signal of the target channel is the first polarization; and

determining, based on the second polarization manner in the parameters of the target channel, to supply power for the motor using the power supply voltage for the antenna in the second polarization manner.

In some embodiments, the controlling a power supply voltage for the motor based on a power supply voltage for the antenna in a second polarization manner includes: supplying, by the control device, power for the motor using the power supply voltage for the antenna in the second polarization manner, when the control device includes a power source; or when the control device does not include any power source, controlling, by the control device, a power system to supply power for the motor using the power supply voltage for the antenna in the second polarization manner.

Therefore, in some embodiments, when it is determined, based on the channel polarization manner in the parameters of the target channel, that the polarization manner of the satellite-transmitted radio wave that sends the target channel signal is the first polarization, power supply for the motor is controlled based on the power supply voltage for the antenna in the second polarization manner. Because the power supply voltage for the antenna in the second polarization manner is higher than the power supply voltage for the antenna in the first polarization manner, rotation of the motor can be accelerated, thus reducing time for the motor to rotate to the preset position in switching between programs over different satellites of the first polarization manner.

At operation 230, the control device sends a rotation instruction to the motor.

It should be understood that the rotation instruction sent by the control device to the motor includes a preset position for rotation.

At operation 240, determine that the motor rotates to the preset position.

In some embodiments, the determining whether the motor rotates to the preset position includes: detecting, by determining module 310 or processor 410, a power supply current of the antenna after the rotation instruction is sent to the motor; and determining, based on the power supply current of the antenna that the motor rotates to the preset position.

In some embodiments, the determining, based on the power supply current of the antenna, that the motor rotates to the preset position, includes: determining that the motor rotates to the preset position when a difference between the detected power supply current of the antenna and a power supply current of the antenna before the motor rotation instruction is sent is less than a first threshold.

In some embodiments, before rotating of the motor, the power supply current of the antenna is a constant current, where the constant current is a current flowing through a high frequency tuner LNB. After the motor starts to rotate, the power supply current of the antenna is the current flowing through the high frequency tuner LNB and a current flowing through the motor. Generally, a working current of the motor is three times a working current of the high frequency tuner LNB. Therefore, after the rotation instruction is sent to the motor by the control device, the power supply current of the antenna is detected. When the difference between the power supply current of the antenna detected after the rotation instruction is sent to the motor and the power supply current of the antenna before the motor rotation instruction is sent is less than the first threshold, it is determined that the motor rotates to the preset position.

In some embodiments, the determining, based on the power supply current of the antenna, that the motor rotates to the preset position, includes: determining that the motor rotates to the preset position when the power supply current of the antenna is a first power supply current, where the first power supply current is the working current of the high frequency tuner LNB.

In some embodiments, the determining that the motor rotates to the preset position includes: receiving a first message sent by the motor, where the first message is used to indicate that the motor rotates to the preset position; and determining, based on the first message that the motor rotates to the preset position.

In some embodiments, when a DiSEqC system supports bidirectional communications, software backreading may be used to determine whether the motor rotates to the preset position. When the motor rotates to the preset position, the first message is sent to the control device, where the first message is used to indicate that the motor rotates to the preset position; and the control device determines, upon reception of the first message, that the motor rotates to the preset position.

In some embodiments, when the difference between the power supply current of the antenna detected by the control device and the power supply current of the antenna before the motor rotation instruction is sent is greater than or equal to the first threshold, when the detected power supply current of the antenna is not the first power supply current or when the control device has not received the first message, the control device should continue to detect the power supply current of the antenna or wait for the first message.

At operation 250, the control device controls the antenna to receive the signal using the first polarization manner, when it is determined that the motor rotates to the preset position.

In some embodiments, the controlling the antenna to receive the signal using the first polarization manner, when the motor rotates to the preset position, includes:

restoring a stored polarization manner of the satellite-transmitted radio wave that sends the signal of the target channel to the first polarization; and

controlling, based on the stored first polarization manner of the satellite-transmitted radio wave that sends the signal of the target channel, the antenna to receive the signal using the first polarization manner.

It should be understood that when a satellite antenna receives a satellite television broadcast signal, a polarization manner of the antenna needs to be the same as a polarization manner of the received satellite television broadcast signal to achieve polarization matching, or else the satellite television broadcast signal cannot be received.

Therefore, in some embodiments, when it is determined, based on the channel polarization manner in the parameters of the target channel, that the polarization manner of the satellite-transmitted radio wave that sends the signal of the target channel is the first polarization, power supply for the motor is controlled based on the power supply voltage for the antenna in the second polarization manner; and when it is determined that the motor rotates to the preset position, the antenna is controlled to receive the signal using the first polarization manner. Because the power supply voltage for the antenna in the second polarization manner is higher than the power supply voltage for the antenna in the first polarization manner, rotation of the motor can be accelerated, thus reducing time for the motor to rotate to the preset position in switching between programs over different satellites, thereby improving user experience.

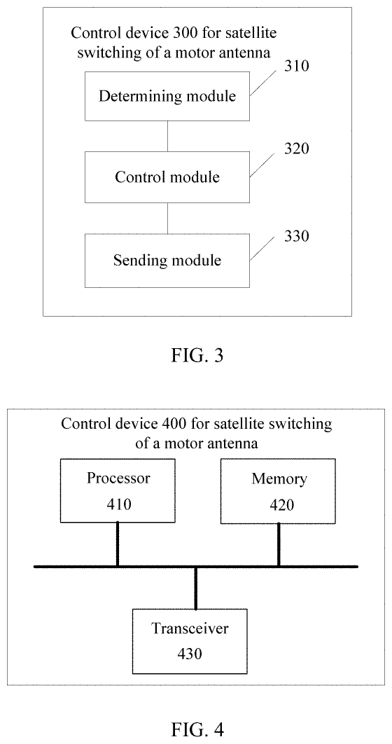

FIG. 3 is a schematic block diagram of a control device 300 for satellite switching of a motor antenna according to at least one embodiment of the present disclosure.

As shown in FIG. 3, the control device includes:

a determining module 310, configured to determine, based on a satellite longitude in read parameters of a target channel, that a current channel and the target channel correspond to satellites of different longitudes;

a control module 320, configured to control power supply for a motor based on a power supply voltage for the antenna in a second polarization manner, when it is determined, based on a channel polarization manner in the parameters of the target channel, that a polarization manner of a satellite-transmitted radio wave that sends a signal of the target channel is first polarization, where the power supply voltage for the antenna in the second polarization manner is higher than a power supply voltage for the antenna in a first polarization manner; and

a sending module 330, configured to send a rotation instruction to the motor;

In some embodiments, the determining module 310 is further configured to determine that the motor rotates to a preset position; and

In some embodiments, the control module 320 is further configured to restore the polarization manner of the antenna to the first polarization, when it is determined that the motor rotates to the preset position.

In some embodiments, the determining module 310, the control module 320, and the sending module 330 are configured to perform the operations in the method 200 for satellite switching of a motor antenna in this application. For brevity, details are not described herein again.

FIG. 4 is a schematic block diagram of a control device 400 for satellite switching of a motor antenna according to at least one embodiment of the present disclosure. The control device 400 includes:

a processor 410, configured to execute program code in a memory 420;

the memory 420, configured to store a program, where the program includes code; and

a transceiver 430, configured to communicate with another device.

In some embodiments, the processor 410 can implement the operations in the method 200 when the code is executed. For brevity, details are not described herein again. The transceiver 430 is configured to implement specific sending or receiving of a signal under driving of the processor 410.

A person of ordinary skill in the art can be aware that the units and algorithm steps in the examples described with reference to the disclosed embodiments herein may be implemented by electronic hardware, or a combination of computer software and electronic hardware. Whether these functions are performed by hardware or software depends on specific applications and design constraints of the technical solutions. A person skilled in the art may use a different method to implement the described functions for each particular application, but such implementation should not be considered as beyond the scope of this application.

A person skilled in the art can clearly understand that, for convenience and brevity of description, for a specific working process of the system, apparatus and unit described above, reference may be made to the corresponding process described in the foregoing method embodiments, and details are not described herein again.

From the several embodiments provided in this application, it should be understood that the disclosed system, apparatus, and method may be implemented in other manners. For example, the apparatus embodiments described above are merely illustrative. For example, the unit division is merely logical function division and may be other division in actual implementation. For example, a plurality of units or components may be combined or integrated into another system, or some features may be ignored or not performed. In addition, the mutual couplings, direct couplings or communication connections shown or discussed may be indirect couplings or communication connections through some interfaces, apparatuses or units, and may be in electrical, mechanical or other forms.

Units described as separate components may or may not be physically separate. Components displayed as units may or may not be physical units. To be specific, such components may be located in one place, or may be distributed onto a plurality of network units. Some or all of units may be selected based on an actual need to implement the solution of the embodiments.

In addition, the functional units in the embodiments of this application may be integrated into one processing unit, or each of the units may exist alone physically, or two or more units may be integrated into one unit.

If implemented as a software functional unit and sold or used as a standalone product, the function may be stored in a computer readable storage medium. Based on such an understanding, the technical solutions of this application essentially, or the part contributing to the prior art, or some of the technical solutions may be implemented in a form of a software product. The software product is stored in a storage medium, including several instructions for instructing a computer control device (which may be a personal computer, a server, a network control device, or the like) to perform all or some of the steps in the method of the embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method, comprising:
determining, based on a satellite longitude of stored parameters of a target channel, that a current channel and the target channel correspond to satellites of different longitudes;
controlling a power supply for a motor based on a power supply voltage for an antenna having a second polarization in response to determining, based on a channel polarization of the stored parameters of the target channel, that a polarization of a satellite-transmitted radio wave of the target channel is a first polarization, wherein the power supply voltage for the antenna having the second polarization is larger than a power supply voltage for the antenna having the first polarization;
sending a rotation instruction to the motor;
determining that the motor rotates to a preset position; and
controlling the antenna to receive a signal having the first polarization in response to determining that the motor rotates to the preset position.

2. The method according to claim 1, wherein the first polarization is a vertical polarization and the second polarization is a horizontal polarization.

3. The method according to claim 1, wherein the first polarization is a right-handed polarization and the second polarization is a left-handed polarization.

4. The method according to claim 1, wherein the controlling the power supply for the motor based on the power supply voltage for the antenna having the second polarization in response to the determining that the polarization of the satellite-transmitted radio wave of the target channel is the first polarization, comprises:
adjusting the channel polarization of the stored parameters of the target channel to be the second polarization in response to the determining that the polarization of the satellite-transmitted radio wave of the target channel is the first polarization; and
determining to supply a power for the motor using the power supply voltage for the antenna having the second polarization in response to the adjusting the channel polarization of the stored parameters of the target channel to be the second polarization; and
the controlling the antenna to receive the signal having the first polarization in response to determining that the motor rotates to the preset position comprises:
restoring the channel polarization of the satellite-transmitted radio wave of the target channel to be the first polarization; and
controlling the antenna to receive the signal using the first polarization in response to the restoring the channel polarization of the satellite-transmitted radio wave of the target channel being the first polarization.

5. The method according to claim 1, wherein the determining that the motor rotates to the preset position comprises:
detecting a power supply current of the antenna after the rotation instruction is sent to the motor; and
determining that the motor rotates to the preset position based on the power supply current of the antenna.

6. The method according to claim 5, wherein the determining that the motor rotates to the preset position based on the power supply current of the antenna comprises:
determining that the motor rotates to the preset position in response to determining that a difference between the power supply current of the antenna and a power supply current of the antenna before the motor rotation instruction is sent is less than a first threshold.

7. The method according to claim 1, wherein the determining that the motor rotates to the preset position comprises:
receiving a first message indicating that the motor rotates to the preset position; and
determining, based on the first message, that the motor rotates to the preset position.

8. A control device, comprising:
a transceiver configured to perform sending or receiving of a signal;
a memory having computer readable executable instructions stored thereon; and
a processor coupled with the memory, and configured to execute the executable instructions control device for:
determining, based on a satellite longitude of stored parameters of a target channel, that a current channel and the target channel correspond to satellites of different longitudes;
controlling a power supply for a motor based on a power supply voltage for an antenna having a second polarization in response to determining, based on a channel polarization the stored parameters of the target channel, that a polarization of a satellite-transmitted radio wave of the target channel is a first polarization, wherein the power supply voltage for the antenna having the second polarization is larger than a power supply voltage for the antenna having the first polarization;
sending a rotation instruction to the motor;
determining that the motor rotates to a preset position; and
controlling the antenna to receive a signal having the first polarization in response to the determining that the motor rotates to the preset position.

9. The control device according to claim 8, wherein the first polarization is a vertical polarization and the second polarization is a horizontal polarization; or,
the first polarization is a right-handed polarization and the second polarization is a left-handed polarization.

10. The control device according to claim 8, wherein
the processor is specifically configured to execute instructions for:
adjusting the channel polarization of the stored parameters of the target channel to be the second polarization in response to the determining that the polarization of the satellite-transmitted radio wave of the target channel is the first polarization; and
determining to supply a power for the motor using the power supply voltage for the antenna having the second polarization in response to the adjusting the channel polarization of the stored parameters of the target channel to be the second polarization; and
when the motor rotates to the preset position, the processor is specifically configured to execute instructions for:
restoring the channel polarization of the satellite-transmitted radio wave of the target channel to be the first polarization; and
controlling the antenna to receive the signal using the first polarization in response to the restoring the channel polarization of the satellite-transmitted radio wave of the target channel being the first polarization.

11. The control device according to claim 8, wherein the processor is specifically configured to execute the instructions for: detecting a power supply current of the antenna after the rotation instruction is sent to the motor; and
determining that the motor rotates to the preset position based on the power supply current of the antenna.

12. The control device according to claim 11, wherein the processor is specifically configured to execute instructions for:
determining that the motor rotates to the preset position in response to determining that a difference between the power supply current of the antenna and a power supply current of the antenna before the motor rotation instruction is sent is less than a first threshold.

13. The control device according to claim 8, wherein the processor is specifically configured to execute instructions for:
receiving a first message indicating that the motor rotates to the preset position; and
determining, based on the first message, that the motor rotates to the preset position.

14. The control device according to claim 8, wherein the first polarization is a left-handed circular polarization and the second polarization is a right-handed circular polarization.

15. A non-transitory computer-readable storage medium comprising computer readable instructions stored thereon that, when executed by a processor, cause a system to:
determine, based on a satellite longitude of stored parameters of a target channel, that a current channel and the target channel correspond to satellites of different longitudes;
control a power supply for a motor based on a power supply voltage for an antenna having a second polarization in response to a determination, based on a channel polarization of the stored parameters of the target channel, that a polarization of a satellite-transmitted radio wave of the target channel is a first polarization, wherein the power supply voltage for the antenna having the second polarization is larger than a power supply voltage for the antenna having the first polarization;
send a rotation instruction to the motor;
determine that the motor rotates to a preset position; and
control the antenna to receive a signal having the first polarization in response to the determination that the motor rotates to the preset position.

16. The non-transitory computer-readable storage medium according to claim 15, wherein the first polarization is a vertical polarization and the second polarization is a horizontal polarization; or,
the first polarization is a right-handed polarization and the second polarization is a left-handed polarization.

17. The non-transitory computer-readable storage medium according to claim 15, wherein
the computer readable instructions that cause the system to control the power supply for the motor based on the power supply voltage for the antenna having the second polarization in response to the determination that the polarization of the satellite-transmitted radio wave of the target channel is the first polarization comprises causing the system to:
adjust the channel polarization of the stored parameters of the target channel to be the second polarization in response to the determination that the polarization of the satellite-transmitted radio wave of the target channel is the first polarization; and
determine to supply a power for the motor using the power supply voltage for the antenna having the second polarization in response to the channel polarization of the stored parameters of the target channel being adjusted to be the second polarization; and,
the computer readable instructions that cause the system to control the antenna to receive the signal having the first polarization in response to the determination that the motor rotates to the preset position comprises causing the system to:
restore the channel polarization of the satellite-transmitted radio wave of the target channel to be the first polarization; and
control the antenna to receive the signal using the first polarization in response to the the channel polarization of the satellite-transmitted radio wave of the target channel being restored as the first polarization.

18. The non-transitory computer-readable storage medium according to claim 15, wherein the computer readable instructions that cause the system to determine that the motor rotates to the preset position comprises causing the system to:
detect a power supply current of the antenna after the rotation instruction is sent to the motor; and
determine that the motor rotates to the preset position, based on the power supply current of the antenna.

19. The non-transitory computer-readable storage medium according to claim 18, wherein the computer readable instructions that cause the system to determine that the motor rotates to the preset position based on the power supply current of the antenna comprises causing the system to:
determine that the motor rotates to the preset position in response to a determination that a difference between the power supply current of the antenna and a power supply current of the antenna before the motor rotation instruction is sent is less than a first threshold.

20. The non-transitory computer-readable storage medium according to claim 15, wherein the computer readable instructions that cause the system to determine that the motor rotates to the preset position comprises causing the system to:
receive a first message that indicates that the motor rotates to the preset position; and
determine, based on the first message, that the motor rotates to the preset position.
